(19) United States
(12) Patent Application Publication
(10) Pub. No.: US 2022/0227667 A1
(43) Pub. Date: Jul. 21, 2022

(54) Method for Preparing a Coated Particulate Waste Material and a Coated Waste Particle

(71) Applicant: Delta R&D B.V., HL Goirle (NL)

(72) Inventor: Mijndert Cornelis Ernst Ralf CRETEER, Goirle (NL)

(73) Assignee: Delta R&D B.V., HL Goirle (NL)

(21) Appl. No.: 17/614,726

(22) PCT Filed: Jun. 3, 2020
(86) PCT No.: PCT/EP2020/065329

§ 371 Date: Nov. 29, 2021

(30) Foreign Application Priority Data
Jun. 3, 2019 (NL) 2023250

(51) Int. Cl. C04B 18/08; C04B 24/42; C04B 28/02

(52) U.S. Cl. CPC C04B 18/08; C04B 2103/0046; C04B 28/02; C04B 24/42

(57) ABSTRACT

The current invention concerns a method for preparing a coated particulate waste material, comprising the steps of: (a) providing a particulate waste material with an average particle size of between 0.1 and 5.0 mm, and (b) applying a coating material to said particulate waste material, whereby said coating material comprises at least one polymeric compound.

In a second aspect the present invention discloses a coated waste particle comprising a waste material core, and a coating surrounding said waste material core, whereby said waste material core has a particle size of between 0.1 and 5.0 mm and said coating comprises at least one polymeric compound.

A further aspect concerns a building material, comprising one or more coated waste particles.

### TECHNICAL FIELD

The invention pertains to the technical field of the recycling and/or reuse of waste material and, more particularly, discloses a method for preparing a coated particulate waste material.

### BACKGROUND

Large amounts of municipal and industrial solid waste are produced on a daily basis. Although recycling has come a long way, a large fraction of solid waste still ends up in an incinerator. Incineration reduces the municipal solid waste volume by up to ninety percent. However, the residue remaining must still be deposited in a landfill. If the fly ash and bottom ash residues resulting from incineration could be used to manufacture useful by-products, the landfill requirement would be substantially reduced. Waste incineration ash however comprises a multitude of contaminants, rendering them environmentally unacceptable, or even unusable for some recycling applications. It is e.g. known that the presence of aluminum oxide in incineration ash limits the use of said ash in the manufacture of concrete.

Therefore it is common to wash and/or rinse incineration ashes in order to obtain a cleansed product, suitable for recycling, with minimized leaching of contaminants. This is however expensive, time-consuming and does not always guarantee high quality results. As a result, landfilling is commonly still more preferred. Hence, a more efficient alternative is needed, to allow for the efficient recycling and/or reuse of waste materials.

In this light, EP 0 582 008 is directed to the manufacture of an aggregate which is composed primarily of processed municipal solid waste ash which has been rendered environmentally acceptable, and a suitable cementitious material and pozzolan. The manufacture of said aggregate however comprises a multitude of complex steps, like the fixation of metals with an alkali silicate, the addition of a cementitious binder and pelletizing the mixture, obtaining pellets with a sealing coating. Although the inefficient step of washing is eliminated, the method as herein disclosed is still complex, expensive and time-consuming, and as a result not practicable for recycling purposes.

Furthermore, only sequestration of metals is aimed at, while other contaminants are not affected.

U.S. Pat. No. 4,804,147 describes a method comparable with washing, whereby a heavy metal immobilizing agent and a volumetric stabilizing agent are brought into contact with incineration ash, obtaining individual stabilized particles. Only heavy metals are targeted, thus not affecting the leaching of other contaminants.

WO 1997 031 874 uses sodium hexametaphosphate in order to inert ash containing heavy metals and aluminum metal. The inerted ash is formed into a hardened material comprising hydraulic mortar. Nonetheless heavy metals and aluminum are targeted, other contaminants are not affected. Furthermore, the treated ash is not reusable as such, i.e. a particulate material, but is only reusable in a fixed aggregate.

Furthermore, KR 101 866 908 relates to a process for producing a color aggregate by coloring thermosetting resin and pigment on bottom ash particles obtained by pulverizing recycled bottom ash. U.S. Pat. No. 5,180,638 discloses a method for reducing the leachability of granular material which consists essentially of an inorganic binder and a filler containing contaminants. WO 2015/020199 pertains to surface-coated inorganic particles capable of remarkably shortening kneading time of hydraulic particles, and giving a hydraulic composition excellent fluidity. U.S. Pat. No. 4,621,024 relates to a process for preparing a metal-coated hollow microsphere.

There remains a need in the art for an improved methodology of recycling and/or reusing particulate waste materials, whereby leaching of contaminants is efficiently minimized.

The present invention aims to resolve at least some of the problems mentioned above.

### SUMMARY OF THE INVENTION

The present invention and embodiments thereof serve to provide a solution to one or more of above-mentioned disadvantages. To this end, in a first aspect the present invention relates to a method for preparing a coated particulate waste material, according to claim 1. Leaching of contaminants is efficiently minimized by applying a coating to said waste material, thereby containing a broad group of potential contaminants inside the coated particle.

In a further aspect, the present invention provides a coated waste particle according to claim 15, said particle comprising a waste material core, and a coating surrounding said core.

A further aspect of the present invention discloses a building material according to claim 23, comprising one or more of said coated waste particles. The building material is particularly suited as a lightweight concrete alternative.

In particular the current invention is defined by the following, not limitative embodiments.
1. Method for preparing a coated particulate waste material, comprising the steps of:
   (a) providing a particulate waste fraction with an average particle size of between 0.1 and 5.0 mm, and
   (b) applying a coating material to said particulate waste fraction wherein said coating material comprises at least one polymeric compound.
2. Method according to embodiment 1, wherein the particulate waste fraction is obtained by separating a particulate waste material.
3. Method according to embodiment 1 or 2, wherein said particulate waste fraction has an average particle size of between 0.5 and 4.0 mm.
4. Method according to any of the embodiments 1-3, wherein said particulate waste fraction is a contaminated waste material.
5. Method according to any of the embodiments 1-4, wherein said applying a coating material of step (c) comprises:
   (i) providing the particulate waste fraction,
   (ii) providing the coating material,
   (iii) homogeneously distributing said coating material onto the surface of said particulate waste fraction,
   (iv) fixating said coating material onto said surface, thereby obtaining the coated particulate waste material.
6. Method according to any of the embodiments 1-5, wherein said particulate waste fraction and coating material are provided in a ratio of between 100:1 to 100:25 by weight, preferably of between 100:2 to 100:20 by weight.
7. Method according to any of the embodiments 1-6, wherein said at least one polymeric compound is selected from the group of monomers, dimers, oligomers, polymers, copolymers, cross-linking agents, or combinations thereof.
8. Method according to any of the embodiments 1-7, wherein said coating material comprises a silane coupling agent.
9. Method according to embodiment 8, wherein said silane coupling agent is a compound with general formula Y—R—Si—(X)₃, wherein Y—R— is an organic moiety comprising a functional group Y that links with organic materials, and X is a functional group that undergoes hydrolysis to a silanol group.
10. Method according to embodiment 8 or 9, wherein said silane coupling agent is present in the coating material in a concentration of between 1.0 and 10.0 wt. % based on the total weight of the coating material.
11. Method according to any of the embodiments 5-10, wherein said distributing of step (iii) comprises spraying, submerging, dipping, or combinations thereof.
12. Method according to any of the embodiments 5-11, wherein said fixating of step (iv) comprises a chemical reaction, drying, heating, irradiation, cross-linking, or combinations thereof.
13. Method according to any of the embodiments 5-12, wherein said particulate waste fraction is selected from the group of wood ash, bottom ash, fly ash, or combinations thereof.
14. Method according to any of the embodiments 5-13, wherein said particulate waste fraction is bottom ash.
15. Coated waste particle, said waste particle comprising a waste material core, and a coating surrounding said waste material core, wherein said waste material core has an average particle size of between 0.1 and 5.0 mm, and wherein said coating comprises at least one polymeric compound.
16. Coated waste particle according to embodiment 15, wherein said waste material core has an average particle size of between 0.5 and 4.0 mm.
17. Coated waste particle according to embodiment 15 or 16, wherein said coating has an average layer thickness of between 0.05 and 1.00 mm.
18. Coated waste particle according to any of the embodiments 15-17, wherein said at least one polymeric compound comprises monomers, dimers, oligomers, polymers, copolymers, cross-linking agents, or combinations thereof.
19. Coated waste particle according to any of the embodiments 15-18, wherein said waste material core comprises wood ash, bottom ash, fly ash, or combinations thereof.
20. Coated waste particle according to embodiment 19, wherein said waste material core comprises bottom ash.
21. Coated waste particle according to any of the embodiments 15-20, obtained by a method according to any of the embodiments 1-14.
22. Use of a coated waste particle according to any of the embodiments 15-21, as a replacement for sand in building materials.
23. Building material, comprising one or more coated waste particles according to any of the embodiments 15-21, whereby said coated waste particles are bound in the building material by means of a binding agent.
24. Building material according to embodiment 23, whereby said binding agent comprises one or more chemically and/or mechanically binding substances, chosen from the non-limiting group of Portland cement, rapid hardening cement, sulphate resisting cement, high alumina cement, ferro-cement, pozzolanic cement, gypsum cement, magnesium cement, acid-resistant cement, asphalt, bitumen, polyvinylacetate, resins, or combinations thereof.
25. Building material according to embodiment 23 or 24, whereby said building material is shaped into a building block.
26. Building material according to any of the embodiments 23-25, whereby said building material is an equivalent, an alternative and/or a replacement for concrete.

The novel features of the invention are set forth with particularity in the appended claims. A better understanding of the features and advantages of the present invention will be obtained by reference to the following detailed description that sets forth illustrative embodiments, in which the principles of the invention are utilized.

### DETAILED DESCRIPTION OF THE INVENTION

The present invention concerns a method for preparing a coated particulate waste material.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

In a first aspect, the invention provides a method for preparing a coated particulate waste material, comprising the steps of: (a) providing a particulate waste material, (b) separating said particulate waste material, obtaining a separated waste fraction with an average particle size of between 0.1 and 5.0 mm, and (c) applying a coating material to said separated waste fraction.

For clarity, the present method relates to coating of a particulate waste material within the above-mentioned average particle size range. The actual separation step is therefore optional in as far as the particulate waste material as such does or does not fall within the herein described size ranges. Therefore, in the following embodiments the wording “particulate waste material” will also be referred to as “particulate waste fraction”, meaning that the particulate waste fractions falls within the average particle size range as claimed.

Accordingly, the invention provides a method for preparing a coated particulate waste material, comprising the steps of: (a) providing a particulate waste fraction with an average particle size of between 0.1 and 5.0 mm, and (b) applying a coating material to said particulate waste fraction. According to the present invention, said coating material comprises at least one polymeric compound.

The wording “waste material” refers to unwanted or unusable materials. It is any substance which is discarded after primary use, or is worthless, defective and/or of no further use. In the context of the present invention, in some embodiments, waste material comprises municipal solid waste, industrial solid waste, hazardous waste, or combinations thereof. In some embodiments, waste material comprises combustion waste, e.g. combustion ash. Although the present invention is mainly directed towards the valuation of waste materials, it is conceivable that the present invention is also applicable to materials which are not per definition waste materials.

The term “particulate”, in the context of the present invention, need be interpreted as comprising one or more particles.

For clarity, the wording “coating material” will herein be used to indicate an unapplied coating substance, whereas the process of coating will be phrased as “applying a coating material”. The final product of the fixed coating surrounding the particle will be distinguished by simply using the wording “coating”.

By the terminology “polymeric compound” a broad range of compounds is indicated, including and not limited to polymers, copolymers, polymeric precursors, monomers, dimers, oligomers and/or cross-linking agents. As described herein, application of the polymeric compound can take place in a multitude of ways. For example, it is possible to use a polymer as such, whereby said polymer could be melted or dissolved in a solvent, for ease of application. Another possibility comprises the application of one or more precursors, wherein the polymer will only be formed after application of the coating material to the particulate waste fraction. As such, the polymer could be the result of a chemical reaction.

The method according to the present invention thus discloses suitable steps to provide for waste materials with an inert character, thereby making reuse and/or recycling of said materials possible. The term “inert” is to be interpreted as physically and/or chemically stable. In the context of the present invention, this means leaching of potential contaminants from the waste material and the chemical reactivity thereof is minimized.

The coating material of the present invention forms a stable barrier on the surface of the waste particles, thereby hindering migration of potential contaminants from the core of the particle to its surface. As a result, leaching of potential contaminants from the particle core is minimized and the coated waste particles are safe for recycling and reuse purposes. Furthermore, coating allows for a fast and efficient alternative to washing or rinsing. Washing or rinsing potential contaminants from waste particulates can be time and energy consuming depending on the degree of contamination, whereas the provision of a coating is equally efficient for relatively high contamination levels.

Moreover, the provision of a protective coating as well as the captivation of potential contaminants inside waste particles is obtained by a single coating method, instead of needing subsequent fixation, rinsing and/or coating steps.

In some embodiments, the particulate waste fraction as such has an average particle size falling within the above-mentioned ranges, thus explicit separation is not carried out, or can already be carried out beforehand.

In some embodiments, the particulate waste fraction is obtained by separating a particulate waste material, and is thus also referred to as the separated waste fraction.

Within the average particle size range according to the present invention, the coating provided to the particulate (separated) waste fraction is optimally adhering to the particle surface. According to some embodiments, said particulate (separated) waste fraction has an average particle size of between 0.2 and 4.0 mm. By preference, said particulate (separated) waste fraction has an average particle size of between 0.3 and 4.0 mm, more by preference between 0.4 and 4.0 mm, even more by preference between 0.5 and 4.0 mm. Within this average particle size range, particles are roughly corresponding to the particle size of “very fine gravel” to “(very) coarse sand” according to the Wentworth aggregate name classes, therefore being applicable in e.g. the production of concrete and further improving the adhering characteristics of the coating on the particulate material. As the presence of potential contaminants can significantly hinder the production of high quality building materials, the method according to the present invention is optimally suitable for preparing particulate waste material which is optimally suitable for reuse in building materials.

More by preference, said particulate (separated) waste fraction has an average particle size of between 0.5 and 3.5 mm, even more by preference between 0.5 and 3.0 mm, most by preference between 0.5 and 2.5 mm. Smaller particles are generally favorable as the adhering characteristics of the coating material to the particulate (separated) waste fraction is further improved. Furthermore, smaller particles comprise a smaller outer surface, which contributes to their inert features as the leaching of contaminants is physically limited by the smaller surface area.

The separation of the particulate waste material to a suitable particle size can be done by any fractionation method known to a person skilled in the art. For completeness, suitable fractionation methods comprise fractionation by sieving, fractionation by density or volumetric mass, sedimentation, or combinations thereof.

A preferred embodiment of the present invention uses sieving as a fractionation method. Sieving has the advantage to be a fast and efficient fractionation method with a relatively high accuracy. Furthermore, sieving functions mainly by restricting to particle size, whereas e.g. volumetric mass fractionation is dependent on the material type. As the present method uses particulate waste as starting material, the material type is per definition mixed, or even possibly unknown. Therefore, fractionation by sieving is the preferred fractionation technique in order to obtain a conclusive particle size.

For improving coating characteristics, controlling the upper particle size limit is of high importance. Fractionation to a certain upper particle size limit can already be achieved with a single sieving step, which allows for notably fast separation. Preferably sieving is performed in multiple stages, as this allows for both upper and lower particle size limitation and thus allows for better determination of the fractionation range.

According to a further or another embodiment, said particulate waste material is a contaminated waste material. Contamination of the waste material comprises metals, in particular heavy metals, and derivatives thereof, like chrome, cobalt, nickel, cadmium, copper, aluminum, mercury and/or lead. Said derivatives comprise salts, hydroxides, oxides and/or silicates of said metals.

According to an embodiment said applying a surface coating comprises: (i) providing the particulate (separated) waste fraction, (ii) providing the coating material, (iii) homogeneously distributing said coating material onto the surface of said particulate (separated) waste fraction, (iv) fixating said coating material onto said surface, thereby obtaining the coated particulate waste material.

The distributing of step iii allows for a homogeneous application of the coating material, therefore improving the adhering characteristics of the coating material onto the particle surface of the particulate (separated) waste fraction. Moreover, the coating material is more evenly distributed and thus the inerting effect of the coating is optimized. Prompt fixation (step iv) of said coating material onto the particulate (separated) waste fraction allows for a permanent, homogenous distribution of the coating material onto the particle surface. This further enhances stability and inertia of the resulting coated particulate waste material, without ‘smoothening’ the surface of the particles. Indeed, for some applications a rather irregular shape of the particles is beneficial, therefore the coating having no particular impact on the shape of the particles is deemed an advantage. As a result, the method according to the present invention is considered a conservative method, which does only enhance inertia. Other characteristics of the particulate material, like outer shape, are optimally left unchanged.

In some embodiments, the coating material provides for minimized leaching of contaminants from the waste particles, while equally enhancing the surface properties of said particles, e.g. in order to improve binding in building materials. In some embodiments, one coating material provides for multiple effects. In some embodiments, the surface coating comprises more than one layer of coating material, whereby the inner coating layer enhances inertia and the outer coating layer enhances binding characteristics.

In an embodiment, said particulate (separated) waste fraction and said coating material are provided in a ratio of between 1000:1 and 1000:500, between 1000:2 and 1000:400, between 1000:5 and 1000:300, or between 100:1 to 100:25 by weight. As larger particles will proportionately contain a higher amount of contaminants than smaller particles, said contaminants being susceptible to unwanted leaching, a higher amount of coating material will consequentially be necessary. Therefore the present invention provides for an optimal weight ratio, enhancing inertia to particles within the specific particle size as disclosed herein.

Preferably, said particulate (separated) waste fraction and said coating material are provided in a ratio of between 100:2 to 100:20 by weight. Even more by preference, said ratio is between 100:3 and 100:15, even more by preference between 100:4 and 100:12. Most by preference, said particulate waste fraction and said coating material are provided in a ratio of between 100:5 to 100:10 by weight. Within the present range, the coating is optimally adhered to the particulate waste material and is fully balanced with the resulting inerting properties.

According to an embodiment, said at least one polymeric compound is selected from the group of monomers, dimers, oligomers, polymers, copolymers, cross-linking agents, or combinations thereof. Said at least one polymeric compound is optimally suited to form a stable layer around the particulate material, minimizing the risk of leaching for potential contaminants like metals, in particular heavy metals and derivatives thereof. Said at least one polymeric compound is especially suited for minimizing leaching of chrome, cobalt, nickel, cadmium, copper, aluminum, mercury and/or lead. Said derivatives comprise salts, hydroxides, oxides and/or silicates of said metals. Suitable polymeric compounds include and are not limited to polyfosfazenes, polyvinylalcohols, amides, polyamides, polyesteramides, polyaminoacids, polyanhydrides, carbonates, polycarbonates, acrylates, polyacrylates, polyalkylenes, polyacrylamides, polyalkyleneglycoles, polyalkylenenoxides, polyalkylenetereftalates, polyorthoesters, polyvinylethers, polyvinylesters, polyvinylhalogenides, esters, polyesters, lactides, polylactides, polyglycolides, polysiloxanes, urethanes, polyurethanes, ethers, polyethers, polyetheramides, polyetheresters, polystyrene, propylene, polypropylene, polyvinylphenol, polyvinylpyrrolidone, chlorinated polybutylene, poly-octadecylvinylether, ethylenevinylacetate, ethylene, polyethylene, polyoxymethylene, poly-ethyleneoxide, poly-ethylenetereftalate, polyethyleen/nylon-entcopolymer, polycaprolactone/polyamide bock copolymeer, poly-caprolactone di methacrylate-n-butylacrylate, polyvinylchloride, urethane/butadiene-copolymers, polyurethane block copolymers, styrene-butadiene-styrene block copolymers, urethane-acrylic copolymers, copolymers of any of the previous polymers, or combinations thereof.

Said at least one polymeric compound is according to a further or another embodiment selected from the group of ethylene, polyethylene, propylene, polypropylene, amides, polyamides, esters, polyesters, ethers, polyethers, lactides, polylactides, urethanes, polyurethanes, urethane-acrylic copolymers, or combinations thereof. The coating material of the present embodiment is optimized for sequestering metal oxides and or hindering their migration. Said metal oxides in particular comprise aluminum oxide. By preference, said at least one polymeric compound is selected from the group of esters, polyesters, urethanes, polyurethanes, urethane-acrylic copolymers, or combinations thereof. Said compounds have the advantage of hardening out rapidly, being highly resistant to abrasion, chemicals and UV light.

According to a further or another embodiment, said coating material comprises a silane coupling agent. The presence of a silane coupling agent in the coating material has the advantage that adhesion of the coating material on the particle surface is further improved. As a result, the coating process is especially fast and efficient, and results in a coating which is optimally adhered to the particulate (separated) waste fraction and is fully balanced with the resulting inerting properties. Furthermore, the silane coupling agent ensures that the coating can be applied to a wide array of materials, rendering the present coating method exceptionally versatile.

By preference, said silane coupling agent is a compound with general formula Y—R—Si—(X)₃, wherein Y—R— is an organic moiety comprising a functional group Y that links with organic materials, and X is a functional group that undergoes hydrolysis to a silanol group. In particular, X undergoes hydrolysis by water or moisture to form a silanol group, which is suitable to link with inorganic materials. Representative examples of X include but are not limited to chlorine, alkoxy, and acetoxy group. The silane coupling agent as described herein, is especially effective for the improved adhesion at the interface between organic and inorganic materials.

According to a further or another embodiment, said silane coupling agent is present in the coating material in a concentration of between 1.0 and 10.0 wt. % based on the total weight of the coating material. The coating material adheres exceptionally well to a wide variety of materials, ensuring optimal reduction of leaching characteristics of the resulting coated particles. By preference, the coating material is present in a concentration of between 1.0 and 8.0 wt. %, more by preference of between 1.0 and 5.0 wt. %, even more be preference of between 2.0 and 4.0 wt. %, most by preference of between 2.5 and 3.5 wt. % based on the total weight of the coating material.

Said distributing of step (iii) comprises according to an embodiment of the invention spraying, submerging, dipping, or combinations thereof. Said techniques allow for a fast and efficient, homogeneous application of the coating material onto the particle surface of the particulate (separated) waste fraction. Furthermore, said distributing means can easily be implemented in a continuous production process, thereby obtaining high-throughput, high quality results.

A most preferred distribution technique comprise spraying as it provides for a high quality, homogeneous distribution in a very efficient way. Implementation of a spraying technique in a continuous production process is straight-forward, and as a result of its easy set-up and maintenance, interruptions are very rarely necessary. Spraying is particularly suited for the application of a liquid coating material.

According to an embodiment, said fixating of step (iv) comprises a chemical reaction, drying, heating, irradiation, cross-linking, or combinations thereof.

Said particulate waste material is according to an embodiment of the present invention selected from the group of wood ash, bottom ash, fly ash, or combinations thereof.

In the context of the present invention, the wording “ash” indicates the solid remains of combustion processes. The term “wood ash” refers to the solid combustion remains of wood. The terms “fly ash” and “bottom ash” respectively refer to the light, pulverized, and particulate fraction resulting of combustion, often accompanied by flue gases, and the heavy, non-combustible residue thereof.

Said ash materials are abundantly available through a multitude of both industrial and domestic combustion processes. The prevalence of a high amount of contaminants in said ashes however limits their applicability for reuse or recycling purposes, and treatment thereof is commonly rather expensive. The method of the present invention provides the opportunity of inerting said ashes by providing a coating to them, therefore allowing them to be reused and/or recycled in e.g. building materials. Said ashes commonly contain a high amount of (heavy) metal components which are effectively captivated within the waste particle core by the application of a surface coating according to the present invention. Leaching of (heavy) metal components is accordingly minimized.

By preference, said waste material is bottom ash. Bottom ash is at present very difficult and expensive to treat, and comprises a significant amount of e.g. aluminum oxide. As bottom ash is abundantly available through combustion processes, the present method providing for the insertion of bottom ash particles notwithstanding their high contamination degree, is a great opportunity to efficiently reuse and/or recycle this waste material. Leaching of aluminum oxide from the bottom ash particles is hereby minimized. As a result, bottom as can be efficiently reused or recycled in applications where aluminum oxide would normally be a troubling and/or limiting factor e.g. use in building materials.

In a second aspect, the present invention relates to a coated waste particle, said particle comprising a waste material core, and a coating surrounding said waste material core. According to the present invention, said waste material core has an average particle size of between 0.1 and 5.0 mm. Within the particle size range according to the present invention, the coating is optimally adhered to the particle surface of the particulate waste fraction.

In a further or another embodiment, said waste material core has an average particle size of between 0.2 and 4.0 mm, between 0.3 and 4.0 mm, 0.4 and 4.0 mm or 0.5 and 4.0 mm. Within this particle size range, particles are roughly corresponding to the particle size of “very fine gravel” to “(very) coarse sand” according to the Wentworth aggregate name classes, therefore being applicable in e.g. the production of concrete and further improving the adhering characteristics of the coating on the particulate material.

More by preference, said waste material core has an average particle size of between 0.5 and 3.5 mm, even more by preference said waste material core has an average particle size of between 0.5 and 3.0 mm, most by preference said waste material core has an average particle size of between 0.5 and 2.5 mm. Smaller particles are favorable as the adhering characteristics of the surface coating to the waste particles is further improved. Furthermore, a smaller core particle size implies a smaller outside surface, which contributes to the inert character of the coated waste particles. In particular, optimal inertia regarding phenomena like leaching of contaminants is obtained.

According to an embodiment of the present invention, said coating has an average layer thickness of between 0.01 and 1.00 mm, between 0.02 and 1.00 mm or preferably between 0.05 and 1.00 mm. As a result, the surface of the core is fully coated with an adequate amount of coating material in order to obtain optimal inertia towards leaching of contaminants from the core to the outside surface.

By preference, said coating has an average layer thickness of between 0.05 and 0.75 mm, even more by preference, said coating has an average layer thickness of between 0.05 and 0.50 mm. According to some embodiments, the coating has an average layer thickness of between 0.06 and 0.50 mm, between 0.07 and 0.50 mm, between 0.08 and 0.50 mm, between 0.09 and 0.50 mm, or between 0.10 and 0.50 mm. The thinner the coating layer and/or the smaller the variation in thickness of the coating, the smaller the impact of the coating on the outer shape of the coated particle will be. According to the present invention, the possibly irregular shape of the waste particle is left mostly unaltered by the coating. As for some applications a rather irregular shape of the particles is beneficial, the coating having no particular impact on the shape of the particles is deemed an advantage. Accordingly and even more by preference, said coating has a layer thickness of between 0.10 and 0.40 mm, between 0.10 and 0.30 mm, or between 0.10 and 0.20 mm, finding optimal balance between inerting characteristics and low impact on the shape of the core particle.

According to an embodiment, said at least on polymeric compound comprises monomers, dimers, oligomers, polymers, copolymers, cross-linking agents, or combinations thereof. The resulting coating is optimally suited for minimizing the risk of leaching of potential contaminants like metals, in particular heavy metals and derivatives thereof. Said coating materials are especially suited for minimizing leaching of chrome, cobalt, nickel, cadmium, copper, aluminum, mercury and/or lead. Derivatives comprise salts, hydroxides, oxides and/or silicates of said metals.

Suitable polymeric compounds include and are not limited to polyfosfazenes, polyvinylalcohols, amides, polyamides, polyesteramides, polyaminoacids, polyanhydrides, carbonates, polycarbonates, acrylates, polyacrylates, polyalkylenes, polyacrylamides, polyalkyleneglycoles, polyalkylenenoxides, polyalkylenetereftalates, polyorthoesters, polyvinylethers, polyvinylesters, polyvinylhalogenides, esters, polyesters, lactides, polylactides, polyglycolides, polysiloxanes, urethanes, polyurethanes, ethers, polyethers, polyetheramides, polyetheresters, polystyrene, propylene, polypropylene, polyvinylphenol, polyvinylpyrrolidone, chlorinated polybutylene, poly-octadecylvinylether, ethylenevinylacetate, ethylene, polyethylene, polyoxymethylene, poly-ethyleneoxide, poly-ethylenetereftalate, polyethyleen/nylon-entcopolymer, polycaprolactone/polyamide bock copolymeer, poly-caprolactone di methacrylate-n-butylacrylate, polyvinylchloride, urethane/butadiene-copolymers, polyurethane block copolymers, styrene-butadiene-styrene block copolymers, urethane-acrylic copolymers, copolymers of any of the previous polymers, or combinations thereof.

Preferably, said at least one polymeric compound is selected from the group of ethylene, polyethylene, propylene, polypropylene, amides, polyamides, esters, polyesters, ethers, polyethers, lactides, polylactides, urethanes, polyurethanes, urethane-acrylic copolymers, or combinations thereof. The resulting coating of the present embodiment is optimized for sequestering and minimizing migration of metal oxides, in particular aluminum oxide. By preference, said at least one polymeric compound is selected from the group of esters, polyesters, urethanes, polyurethanes, urethane-acrylic copolymers, or combinations thereof. Said compounds have the advantage of hardening out rapidly, being highly resistant to abrasion, chemicals and UV light.

In an embodiment of the present invention, said waste material core comprises wood ash, bottom ash, fly ash, or combinations thereof. Said ash materials are abundantly available through a multitude of both industrial and domestic combustion processes. The limitations toward reuse or recycle of said ashes due to the prevalence of a high amount of contaminants in said ashes are however significantly reduced by the provision of an inerting coating thereto. As a result, said coated ashes provide for new reuse and/or recycling opportunities, e.g. for use in building materials. Said ashes commonly contain a high amount of (heavy) metal components which are effectively captured inside the core by the surface coating according to the present invention.

By preference, said waste material is bottom ash. Bottom ash is at present very difficult and expensive to treat and comprises a significant amount of e.g. aluminum oxide. The coating hereby provided minimizes leaching of e.g. aluminum oxide, rendering expensive and inefficient methods of rinsing and/or washing of bottom ash unnecessary and otiose. As a result, this abundantly available waste material, can be efficiently reused or recycled in applications where aluminum oxide would normally be a troubling and/or limiting factor e.g. the processing in building materials.

In a preferred embodiment of the present invention, the coated waste particle is obtained by a method according to any of the preceding embodiments.

In some embodiments, the coated waste particle furthermore provides for a lightweight and stable component for use in building material. In some embodiments, the coated waste particle as disclosed herein is used as a replacement for sand in building materials, in particular concrete.

A third aspect of the present invention provides a building material, comprising one or more coated waste particles according to the present invention, whereby said coated waste particles are bound in the building material by means of a binding agent. As contaminants, e.g. aluminum oxide, can have a negative impact on the volumetric stability of the resulting building material, the implementation of coated waste particles in the building material according to the present invention, instead of untreated waste particles is deemed an advantage.

In some embodiments, the building material according to the present invention uses said coated waste particles as a replacement for sand, gravel, or other particulate materials in the total composition of the building material. As the coated particle of the present invention has a desirable particle size for the manufacture of building materials, it can indeed be used as a replacement for commonly used particulates. In some embodiments, the building material of the present invention is a lightweight alternative to commonly used building materials. Indeed, generally the coated particles of the present invention have a lower specific weight than their commonly used counterparts. Physical strength of the resulting building materials is however not negatively impacted.

According to a further or another embodiment, said binding agent comprises chemically and/or mechanically binding substances, chosen from the non-limiting group of Portland cement, rapid hardening cement, sulphate resisting cement, high alumina cement, ferro-cement, pozzolanic cement, gypsum cement, magnesium cement, acid-resistant cement, asphalt, bitumen, polyvinylacetate, resins, or combinations thereof.

In a preferred embodiment, the binding agent is Portland cement, rapid hardening cement and/or pozzolanic cement.

According to an embodiment of the invention, said building material is shaped into a building block, therefore allowing easy handling in building or construction. Building blocks according to the present invention are considerably lightweight, therefore further improving handling.

According to the present invention, said building material is an equivalent, an alternative and/or a replacement for concrete, exhibiting comparable strength characteristics while being considerably lightweight.

It is supposed that the present disclosure is not restricted to any form of realization described previously and that some modifications can be added without reappraisal of the appended claims.

The invention is further described by the following non-limiting examples which further illustrate the invention, and are not intended to, nor should they be interpreted to, limit the scope of the invention.

### EXAMPLES

The following examples are meant to further clarify the disclosure but are not be seen as a limitation of the latter.

### Example 1—Preparation of Coated Particulate Waste Material

Particulate incineration waste material is provided with improved leaching characteristics, therefore making it suitable for reuse in building materials, by following the steps below:

(a) particulate incineration waste material to be coated is collected with an average particle size of 0.5 to 4.0 mm, and

(b) an aliphatic waterborne urethane dispersion (polymeric compound of the coating material) is applied to the particulate waste fraction by spraying, in a ratio of the particulate to the coating material of 100:10.

Optionally, to obtain said desired particle size fraction, the particulate waste material can be separated before, during or after its collection, resulting in the particulate (separated) waste fraction.

By coating the particulate incineration waste material, leaching of potential contaminants from said waste material is minimized. Moreover, the coated particles are particularly useful for use in building materials, as they show improved resistance to abrasion, chemicals and UV light. The particle size which is used, allows the use of the coated particulate waste material as a replacement for sand in e.g. concrete, meanwhile allowing optimal adherence of the coating tot the particle surface.

Alternative polymeric compounds to be used are, although not limited to, esters, polyesters, polyurethanes and urethane-acrylic copolymers.

### Example 2—Preparation of Lightweight Concrete Replacement Material

A building material which is both lightweight and ecologically friendly, as it is based on recycled waste material, is prepared by following the steps below:

Preparation of Coated Particulate Waste Material

(a) particulate incineration waste material to be coated is collected,

(b) the collected particulate waste material is separated, whereby a particulate (separated) waste fraction is obtained with an average particle size of 0.5 to 3.0 mm, and

(c) an aliphatic urethane-acrylic copolymer (polymeric compound of the coating material) is applied to the separated waste fraction by spraying, in a ratio of the particulate to the coating material of 100:12.

By coating the particulate incineration waste material, leaching of potential contaminants from said waste material is minimized. An improved resistance to abrasion, scratching, chemicals and UV light allow use of the particulates in building materials. Alternative polymeric compounds to be used are, although not limited to, esters, polyesters, urethanes and polyurethanes.

Preparation of the Lightweight Concrete Replacement Material

The coated particulate waste material is mixed with Portland cement in order to obtain a lightweight concrete replacement material. Mixing is done at a ratio of particulate to cement comparable to ratios used in conventional concrete mixtures, in which e.g. sand is used. The mixture is shaped into building blocks and left to harden.

While being considerably lightweight, the resulting building blocks however have optimal physical strength.

### Example 3—Improved Leaching Characteristics of Coated Waste Material

A column leaching test was conducted according to NEN 7343, following the Dutch Building Materials Decree. Untreated bottom ash was compared to two groups of coated waste materials according to the present invention, showing enhanced leaching characteristics.

| | untreated material | coated material | coated material |
|---|---|---|---|
| substance | (mg/L) | A (mg/L) | B (mg/L) |
| Cl | 1750 | 150 | 125 |
| SO4 | 2850 | 200 | 210 |
| As | 0.35 | 0.02 | 0.01 |
| Ba | 12.00 | 0.82 | 0.65 |
| Pb | 1.155 | 0.020 | 0.015 |
| Cd | 0.028 | 0.003 | 0.002 |
| Cr | 1.75 | 0.05 | 0.10 |
| Cu | 5.85 | 0.18 | 0.12 |
| Hg | 0.00750 | 0.00005 | 0.00006 |
| Ni | 1.235 | 0.025 | 0.020 |
| Zn | 5.85 | 0.15 | 0.20 |

### Example 4—Preparation of Coated Particulate Waste Material

Particulate incineration waste material is provided with improved leaching characteristics, therefore making it suitable for reuse in building materials, by following the steps below:

(a) particulate incineration waste material to be coated is collected with an average particle size of 0.5 to 2.5 mm, and

(b) an aliphatic waterborne urethane dispersion (polymeric compound of the coating material) is applied to the particulate waste material by spraying, in a ratio of the particulate to the coating material of 100:10.

Optionally, to obtain said desired particle size fraction, the particulate waste material can be separated before, during or after its collection, resulting in the particulate (separated) waste fraction.

The coating material further comprises 3.0 wt. % of a silane coupling agent for improved adhesion. By coating the particulate incineration waste material, leaching of potential contaminants from said waste material is minimized. Moreover, the coated particles are particularly useful for use in building materials, as they show improved resistance to abrasion, chemicals and UV light. The particle size which is used, allows the use of the coated particulate waste material as a replacement for sand in e.g. concrete, meanwhile allowing optimal adherence of the coating tot the particle surface.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. Method for preparing a coated particulate waste material, comprising the steps of:
(a) providing a particulate waste fraction with an average particle size of between 0.1 and 0.5 mm, and
(b) applying a coating material to said particulate waste fraction, wherein characterized in that, said coating material comprises at least one polymeric compound.

2. Method according to claim 1, wherein the particulate waste fraction is obtained by separating a particulate waste material.

3. Method according to claim 1, wherein said particulate waste fraction has an average particle size of between 0.5 and 4.0 mm.

4. Method according to claim 1, wherein said particulate waste fraction is a contaminated waste fraction.

5. Method according to claim 1, wherein said applying a coating material of step (c) comprises:
(i) providing the particulate waste fraction,
(ii) providing the coating material,
(iii) homogeneously distributing said coating material onto the surface of said particulate waste fraction,
(iv) fixating said coating material onto said surface, thereby obtaining the coated particulate waste material.

6. Method according to claim 1, wherein said particulate waste fraction and coating material are provided in a ratio of between 100:1 to 100:25 by weight, preferably of between 100:2 to 100:20 by weight.

7. Method according to claim 1, wherein said at least one polymeric compound is selected from the group of monomers, dimers, oligomers, polymers, copolymers, cross-linking agents, or combinations thereof.

8. Method according to claim 1, wherein said coating material further comprises a silane coupling agent.

9. Method according to claim 8, wherein said silane coupling agent is a compound with general formula Y—R—Si—(X)₃, wherein Y—R— is an organic moiety comprising a functional group Y that links with organic materials, and X is a functional group that undergoes hydrolysis to a silanol group.

10. Method according to claim 8, wherein characterized in that, said silane coupling agent is present in the coating material in a concentration of between 1.0 and 10.0 wt. % based on the total weight of the coating material.

11. Method according to claim 10, wherein said distributing of step (iii) comprises spraying, submerging, dipping, or combinations thereof.

12. Method according to claim 1, wherein said fixating of step (iv) comprises a chemical reaction, drying, heating, irradiation, cross-linking, or combinations thereof.

13. Method according to claim 5, wherein said particulate waste fraction is selected from the group of wood ash, bottom ash, fly ash, or combinations thereof.

14. (canceled)

15. A coated waste particle, said waste particle comprising a waste material core, and a coating surrounding said waste material core, wherein said waste material core has an average particle size of between 0.1 and 5.0 mm, wherein said coating comprises at least one polymeric compound.

16. (canceled)

17. The coated waste particle according to claim 15, wherein said coating has an average layer thickness of between 0.05 and 1.00 mm.

18. Coated waste particle according to claim 15, wherein said at least one polymeric compound comprises monomers, dimers, oligomers, polymers, copolymers, cross-linking agents, or combinations thereof.

19. Coated waste particle according to claim 15, wherein said waste material core comprises wood ash, bottom ash, fly ash, or combinations thereof.

20. (canceled)

21. Coated waste particle according to claim 15, obtained by a method for preparing a coated particulate waste material, comprising the steps of:
(a) providing a particulate waste fraction with an average particle size of between 0.1 and 0.5 mm, and
(b) applying a coating material to said particulate waste fraction, wherein said coating material comprises at least one polymeric compound.

22. (canceled)

23. Building material, comprising one or more coated waste particles according to claim 15, whereby said coated waste particles are bound in the building material by means of a binding agent.

24. Building material according to claim 23, whereby said binding agent comprises one or more chemically and/or mechanically binding substances, selected from the group consisting of: Portland cement, rapid hardening cement, sulphate resisting cement, high alumina cement, ferro-cement, pozzolanic cement, gypsum cement, magnesium cement, acid-resistant cement, asphalt, bitumen, polyvinylacetate, resins, and combinations thereof.

25. (canceled)

26. (canceled)
